(19) United States
(12) Patent Application Publication
(10) Pub. No.: US 2017/0132267 A1
(43) Pub. Date: May 11, 2017

(54) PUSHING SYSTEM AND METHOD BASED ON NATURAL INFORMATION RECOGNITION, AND A CLIENT END

(71) Applicants: LE HOLDINGS (BEIJING) CO., LTD., Beijing (CN); LECLOUD COMPUTING CO., LTD., Beijing (CN)

(72) Inventors: Meng ZHOU, Beijing (CN); Ai HAN, Beijing (CN)

(73) Assignees: LE HOLDINGS (BEIJING) CO., LTD., Beijing (CN); LECLOUD COMPUTING CO., LTD., Beijing (CN)

(21) Appl. No.: 15/252,326

(22) Filed: Aug. 31, 2016

Related U.S. Application Data
(63) Continuation of application No. PCT/CN2016/083191, filed on May 24, 2016.

(30) Foreign Application Priority Data
Nov. 11, 2015 (CN) 201510767550.0

(51) Int. Cl. G06F 17/30; G06K 9/72

(52) U.S. Cl. CPC G06F 17/30345; G06K 9/72; G06K 2209/01

(57) ABSTRACT

Disclosed are a push method and electronic devices based on natural information recognition, the method includes, at an electronic device, receiving natural information about an object to be recognized and determining the category of the natural information; performing recognition according to the category of the natural information; analyzing the natural information so as to determine feature meaning of the natural information; and retrieving and determining matching push information according to the feature meaning, the push information preferentially comprising an augmented reality file. The push method and electronic devices provided in the embodiments of the disclosure are beneficial for a user to learn relevant information about anything of the surrounding rapidly, which realizes the pushing of specific information of a specific thing, improving user experience.

### CROSS REFERENCE TO RELATED APPLICATIONS

This application is a continuation of International Application No. PCT/CN2016/083191, filed on 24 May 2016, which is based upon and claims priority to Chinese Patent Application No. 201510767550.0, filed on 11 Nov. 2015, the entire contents of which are incorporated herein by reference.

### TECHNICAL FIELD

The application relates to the technical field of Internet techniques, and in particular to a push system and method based on natural information recognition and a client.

### BACKGROUND

With the high-speed development of informatization, the daily life of people is full of various information resources, and at the same time people are interested in these information resources, such as a propaganda poster of a movie at the street side, a plant at the road side and so on. People who want to know more information upon seeing them can only perform relevant search over the Internet according to text information recorded on the poster or according to the known name of the plant. However, the operation is relatively complex, and if the name of the plant cannot be known, search cannot be realized.

In the prior art, rapid access to a poster or the like is realized by means of providing a two-dimensional code on the poster. However, processing is merely performed at the media end (i.e., on the poster), and in the practical operation, the area of the two-dimensional code is very small, or the two-dimensional code on the pasted propaganda poster is usually provided at the lower left or lower right corner of the poster, which is not convenient for a user to perform scanning using a terminal.

### SUMMARY

The disclosure provides a push system and method based on natural information recognition and a client, which are used for solving the technical problem in the prior art that a user cannot obtain relevant information of interest conveniently and rapidly.

According to an aspect of the disclosure, provided is a push method based on natural information recognition, comprising, at an electronic device, receiving natural information about an object to be recognized and determining the category of the natural information; performing recognition according to the category of the natural information; analyzing the natural information so as to determine feature meaning of the natural information; and retrieving and determining matching push information according to the feature meaning, the push information preferentially comprising an augmented reality file.

According to another aspect of the disclosure, also provided is an electronic device comprising at least one processor and a memory communicably connected with the at least one processor for storing instructions executable by the at least one processor, wherein execution of the instructions by the at least one processor causes the at least one processor to receive natural information and determine the category of the natural information and send the natural information to a recognition server matching the category thereof, the natural information comprising at least one of image information, sound information, text information and location information; and retrieve and determine matching push information according to feature meaning determined by the recognition server analyzing the natural information, the push information preferentially comprising an augmented reality file.

According to another aspect of the disclosure, also provided is an electronic device comprising at least one processor and a memory communicably connected with the at least one processor for storing instructions executable by the at least one processor, wherein execution of the instructions by the at least one processor causes the at least one processor to collect natural information, send the collected natural information to a push system, wherein the push system is used for analyzing the natural information so as to determine feature meaning and retrieving and determining matching push information according to the feature meaning, and receive the push information determined by the push system so as to display the push information, the push information preferentially comprising an augmented reality file.

Further areas of applicability of the present disclosure will become apparent from the detailed description, the claims and the drawings. The detailed description and specific examples are intended for purposes of illustration only and are not intended to limit the scope of the disclosure.

### BRIEF DESCRIPTION OF THE DRAWINGS

In the figures, the direction of an arrow, as indicated by the arrowhead, generally demonstrates the flow of information (such as data or instructions) that is of interest to the illustration. For example, when element A and element B exchange a variety of information but information transmitted from element A to element B is relevant to the illustration, the arrow may point from element A to element B. This unidirectional arrow does not imply that no other information is transmitted from element B to element A. Further, for information sent from element A to element B, element B may send requests for, or receipt acknowledgements of, the information to element A.

One or more embodiments are illustrated by way of example, and not by limitation, in the figures of the accompanying drawings, wherein elements having the same reference numeral designations represent like elements throughout. The drawings are not to scale, unless otherwise disclosed.

FIG. 1 is a schematic diagram of a push system based on natural information recognition according to an embodiment of the disclosure;

FIG. 2 is a schematic diagram of a push system based on natural information recognition according to another embodiment of the disclosure;

FIG. 3 is a schematic diagram of a data search device according to an embodiment of the disclosure;

FIG. 4 is a schematic diagram of a push client based on natural information recognition according to an embodiment of the disclosure;

FIG. 5 is a schematic diagram of a push system based on natural information recognition according to an embodiment of the disclosure; and

FIG. 6 is a flowchart of a push method based on natural information recognition according to an embodiment of the disclosure.

### DETAILED DESCRIPTION

In order to make the purpose, technical solutions, and advantages of the embodiments of the invention more clearly, technical solutions of the embodiments of the disclosure will be described clearly and completely in conjunction with the figures. Obviously, the described embodiments are merely part of the embodiments of the disclosure, but not all embodiments. Based on the embodiments of the disclosure, other embodiments obtained by the ordinary skill in the art without inventive efforts are within the scope of the disclosure.

It should be noted that, embodiments of the present application and the technical features involved therein may be combined with each other in case they are not conflict with each other.

The disclosure is applicable to various general-purpose and specific-purpose computer system environments or configurations, such as a personal computer, a server computer, a handheld device or portable device, a tablet device, a multi-processor system, a microprocessor-based system, a set-top box, a programmable consumer electronic device, a network PC, a mini-computer, a mainframe computer, a distributed computing environment including any of the above-listed systems or devices.

The disclosure can be described in a general context where a computer executes computer-executable instructions, such as program modules. Typically, program modules include routines, programs, objects, components, data structures, etc. which perform certain tasks or implement certain abstract data types. The disclosure can also be implemented in a distributed computing environment, where tasks are performed by a remote processing device connected through a communication network. In a distributed computing environment, program modules may be stored in storage mediums including memory device of the local and remote computer.

Finally, it should also be noted that, wordings like first and second are merely for separating one entity or operation from the other, but not intended to require or imply a relation or sequence among these entities or operations. Further, terms like “include”, “including”, and the like are to be construed as including not only the elements described, but also those elements not specifically described, or further including elements which are essential to such process, method, article or device. Unless the context clearly requires, throughout the description and the claims, elements defined by recitation with “including . . . ” should not be construed as exclusive from the process, method, article or device including said elements of other equivalent elements.

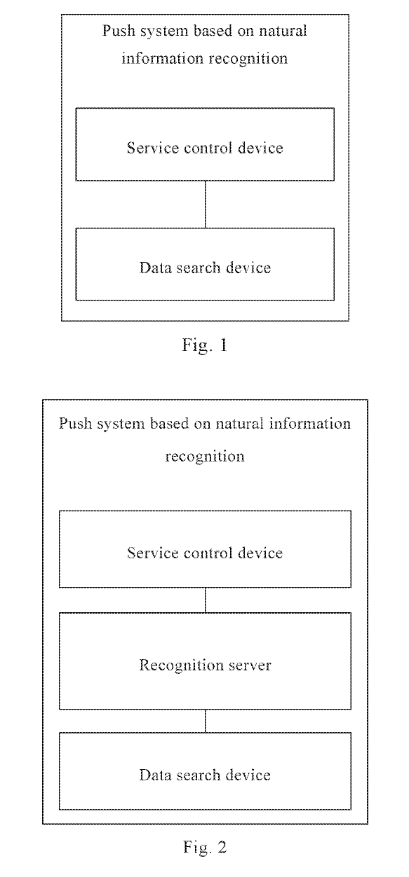

As shown in FIG. 1, a push system based on natural information recognition according to an embodiment of the disclosure, including:

a service control device configured to receive natural information and determine the category of the natural information and send the natural information to a recognition server matching the category thereof, the natural information including at least one of image information, sound information, text information and location information; and

a data search device configured to retrieve and determine matching push information according to feature meaning determined by the recognition server analyzing the natural information received by the service control device, the push information preferably including an augmented reality file.

In the above embodiment of the disclosure, a service control device receives natural information about an object to be recognized, determines the object to be recognized after sending same to a corresponding recognition server according to the category of the natural information for analysis, and sends to a data search device a request to push corresponding information to be pushed, then the data search device invokes pre-stored information to be pushed from a database according to the request information, thus realizing the pushing of relevant information (or customized information) about an object to be recognized. The push information preferably includes an augmented reality file and may also contain a non-augmented reality file at the same time. When there is a corresponding augmented reality file, the augmented reality file can be pushed preferably so as to realize the promotion of information, and when there is no augmented reality file, a non-augmented reality file is pushed to meet the search request of a user, so as to improve user experience.

When the natural information is image information, the feature meaning is a feature point set of an image for determining information to be pushed according to the similarity of the feature point set of the image. When the natural information is sound information or text information, the feature meaning is a keyword or a keyword group in the sound information. When the natural information is text information, the feature meaning is longitude and latitude coordinate values.

In the above embodiment, the push system based on natural information recognition is a server or server group, wherein the service control device and the data search device are respectively a server or server group. At this time, interactions between the service control device and the data search device manifest as the interaction between servers or server groups, and the servers or server groups corresponding to the service control device and the data search device constitute the push system based on natural information recognition in this embodiment. The push system based on natural information recognition in this embodiment including:

a service control server or server cluster configured to receive natural information collected by an external natural information collection terminal and determine the category of the natural information and send the natural information to a recognition server matching the category thereof, the natural information including at least one of image information, sound information, text information and location information; and

a data search server or server cluster configured to retrieve and determine matching push information according to feature meaning determined by the recognition server analyzing the natural information received by the service control server or server cluster, the push information preferably including an augmented reality file.

In some embodiments, the data search device is also configured to send the determined push information to the service control device. The service control device is configured to perform process control on the push information and then send the same to a user.

Process control is performed on the push information and then the same is sent to a user. By way of performing process control on the push information, information pushing and response according to different priorities for different users are realized, thus realizing personalized configuration of users so as to meet different demands of different users.

In this embodiment, the data search device is implemented as a server or server cluster.

As shown in FIG. 2, a push system based on natural information recognition according to an embodiment of the disclosure further includes a recognition server which includes at least one of an image recognition server, a sound recognition server, a text recognition server and a location recognition server.

The recognition server in this embodiment can be set individually or integrally with the data search device, and can also be configured according to the running performance of a server of an operator in a personalized way.

In the above embodiment, the data search device can synchronize data to the recognition server, and by way of updating the database according to a preset period or service demand and synchronizing the data information in the database to the recognition server. Thus, the effective pushing of information to be pushed can be ensured and personalized configuration demand can be satisfied.

In the above embodiment, the service control device receiving natural information may be an imaging device which performs image collection through an image collection device (for example, it can be a camera or a scanner or either). A universal image collection device can be used to reduce the cost of the system. The collection of sound information includes a sound collector and a voice processor, wherein the processing of voice may employ any current third-party voice recognition platform which is the maturest and the most universal. Adopting a mature voice recognition technology improves the accuracy of recognition and ensures the reliability of system running and the goodness of the provided service. The collection of location information can be performed with GPS or a Beidou Navigation Satellite System or both, with one for main use and the other for standby use so as to ensure more reliable and stable quality of service.

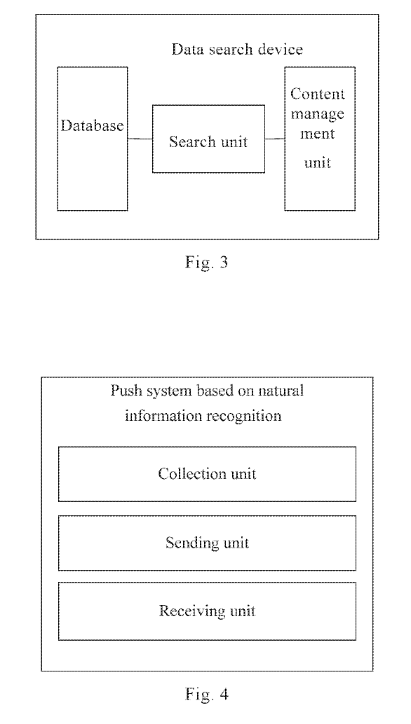

As shown in FIG. 3, a data search device according to an embodiment of the disclosure includes a search unit configured to retrieve information to be pushed from a database according to the received analysis result of the recognition server; a database configured to store an AR augmented file; and a content management unit configured to update the database regularly.

The data search device can extract information to be pushed from the database more efficiently by way of providing a search unit, improving the running efficiency of the entire system. The database is configured individually to store an AR augmented file including at least an AR video and an AR picture and being managed individually, which is beneficial to improve retrieval efficiency and the maintenance and updating of the database, and personalized configured can be performed according to the demand of a customer. The content management unit is also configured to synchronize an ordinary file corresponding to an AR augmented file newly added in the database to the recognition server regularly, so as to realize the data synchronization of the local server (database) and the recognition server, which ensures the subsequent effective running of the push system. The following situation may occur if there is no synchronization: the local server has been updated according to the demand of the customer, but the recognition server has not been synchronized, thus causing failure of the recognition server to find out corresponding content when a user recognizes the promotion content of the customer through an intelligent terminal, and finally causing the failure of the pushing of the customized content, which on one hand brings economic losses to the customer and on the other hand also degrades user experience and also impacts the repute of the service provider.

In this embodiment, the data search device is a server or server cluster, wherein the search unit, the database and the content management unit are respectively a server or server cluster.

As shown in FIG. 4, the disclosure also provides a push client based on natural information recognition, including:

a collection unit configured to collect natural information;
a sending unit configured to send the natural information collected by the collection unit to a push system, wherein the push system analyzes the natural information to determine feature meaning and retrieves and determines matching push information according to the feature meaning; and
a receiving unit configured to receive the push information determined by the push system so as to display the information, the push information preferably including an augmented reality file.

In addition, in this embodiment, a display unit may also be included which is configured to preferably display information about the augmented reality file in the push information.

This display unit is used for displaying information to be pushed. This display unit is configured to be capable of processing and displaying an AR augmented file. The client in this embodiment can realize recognition of different objects and display of corresponding information. Here, the object can be a dynamic entity or can be static image and text information, and can also be audio information.

The object to be recognized in the above embodiment can be obtained through a camera or microphone. In addition, from the perspective of a user, text information can be input through various text input tools, such as a keyboard, a mouse, an input pen, a touch screen and so on. From the perspective of picture search, text information or image information input by the user through various text input tools can be received.

In this embodiment, the push client based on natural information can be an intelligent terminal.

It should be noted that the foregoing embodiments of method are described as a combination of a series of actions for the sake of brief description. The skilled of the art could understand that the application is not restricted by the order of actions as described, because some steps may be carried out in other order or simultaneously in the present application. Further, it should also be understood by the skilled in the art that the embodiments described in the description are preferable, and hence some actions or modules involved therein are not essential to the present application.

In the above embodiments, different emphasis is placed on respective embodiments, and hence for those portions without a detailed description in an embodiment, reference can be made to relevant description of other embodiments.

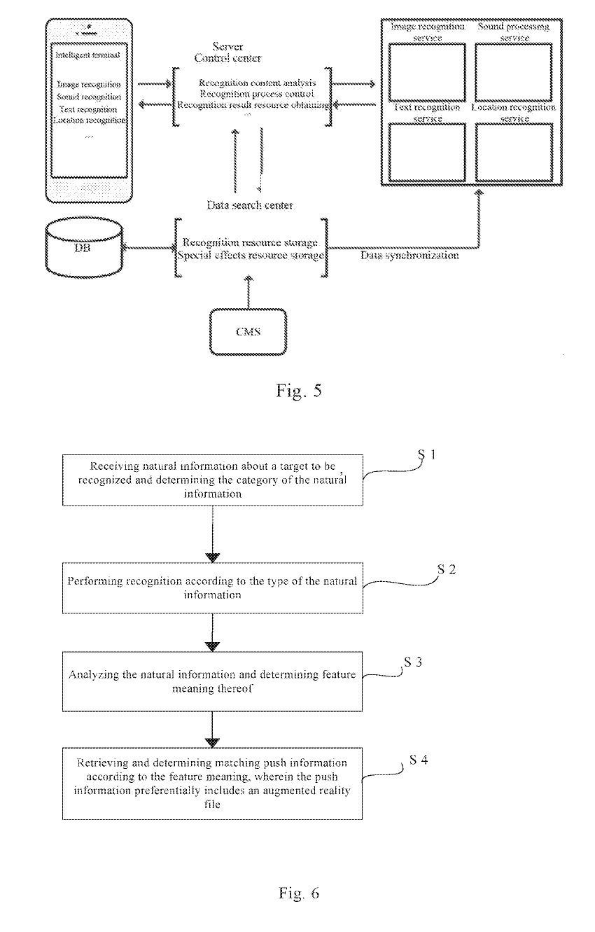

As shown in FIG. 5 which is a schematic diagram of a push system based on natural information recognition according to a particular embodiment of the disclosure, it can be seen that the push system based on natural information recognition includes an intelligent terminal, a service (server) control center (i.e., a service control unit), a cloud server cluster (i.e., a recognition server), a data search center, a database (DB) and a content management center (CMS).

The intelligent terminal can be a mobile phone and can also be a portable, pocket-sized, handheld, computer built-in or on-board mobile device and can also be a PC (personal computer), a tablet and so on, or an intelligent TV which is able to connect to Internet, so that the intelligent terminal can realize the collection of natural information of an object to be recognized.

The service control center receives natural information collected by the intelligent terminal and analyzes the category of the natural information and sends the natural information to a corresponding cloud server in a cloud server cluster, and the service control center in this embodiment is constituted by the servers provided by a plurality of service operators (including a plurality of Unicom front-end machines and a plurality of Telecom front-end machines).

The type of natural information includes one of the following: image information, sound information, text information, and location information, and the natural information about the object to be recognized collected by the intelligent terminal is sent to the cloud server cluster.

The cloud server cluster includes at least one of an image recognition server, a sound recognition server, a text recognition server and a location recognition server.

In practical application, an object to be recognized can be photographed through an intelligent terminal (or the object to be recognized can be be scanned directly through an intelligent terminal) so as to obtain natural information about the object to be recognized, wherein the object to be recognized can be media information (such as a movie, a propaganda poster of a TV series, an advertisement), a plant (such as a tree, a flower and so on), an animal, clothes (such as a backpack, a jacket, a pair of shoes), a book, foods, wine, an intelligent terminal (such as mobile phone, a tablet computer, a printer and so on), a server, a network device, and so on. In addition, audio information about an audio to be recognized can also be collected through a microphone.

The cloud server cluster sends the analysis result of the natural information to a data search center (adopting a virtual server cluster), the data search center finds matching information to be pushed from a database according to the analysis result and sends same to the service control center, and then the service control center pushes to an intelligent terminal the information to be pushed for displaying at an appropriate time. In the above embodiment, the communications between the cloud server cluster and the service control center and the data search center are realized through a switch, and a firewall is provided therebetween so as to ensure data security.

In the above embodiment, the data search center can be a picture search system or a voice search system running at the backstage, such as Baidu, Google picture search and voice search or iFlytek voice search.

The database is a database cluster, which stores customized information relevant to the natural information (the data in the database can be updated regularly according to customized demand). For example, when the natural information is a propaganda poster of a movie, the corresponding database stores content of this movie, such as a trailer, a propaganda film, a movie review, an actor review, a director review or the like, and may also include recommendation information about movies similar to this movie, the movies of the same director, the movies of the same actors and so on. The database stores videos with different code rates for playing at intelligent terminals with different requirements (for example, for intelligent mobile phones and tablets and for 4K large-screen intelligent TV sets). When the natural information is a wine bottle, the database stores various information about this type of wine, such as degree, production place, production date, culture information about this wine, sales information and so on, so that people not only drink wine but also know about wine. When the natural information is sound information, this natural information is collected through a microphone of an intelligent terminal, and the database stores various customized music relevant to this sound information and music with the same style.

In this embodiment, the database cluster is divided into resource database, type database and commodity information library according to type, in which

the resource library at least includes video database, picture database, audio database and 3D resource library, the video database storing all video IDs and video URLs, the picture database storing all picture IDs and picture URLs, the audio database storing all audio IDs and audio URLs, and the 3D resource library storing all 3D resource IDs and 3D resource URLs;

the type library storing without-AR type and with-AR type and redundant space that can be expanded according to demand, wherein the without-AR type includes static name type, direct jump type and corresponding URL; the with-AR type includes picture link type and corresponding jump picture and jump URL, video type and corresponding video source address and jump URL, video picture label type and corresponding video resource address, jump picture and jump URL, audio type and corresponding audio resource address, jump picture and jump URL, 3D type and corresponding 3D resource address, and jump picture and jump URL.

When the information to be pushed in the above embodiment is a video or picture, an AR video and AR picture are pushed, so that the displaying of the information is more realistic, thereby improving user experience.

More preferably, in the above embodiment, an intelligent terminal not only sends collected natural information to a service control center but also sends the attributes thereof (information which indicates the highest code rate for playing, i.e., resolution information) to the service control center, which attribute information is used for determining to push a video with what code rate to the intelligent terminal, so as to not only ensure the playing of the pushed video but also be able to provide the sharpest picture quality. For example, when the intelligent terminal is a mobile phone, the data search center invokes a video with a code rate suitable for playing by the mobile phone from a database. When the intelligent terminal is an intelligent TV, a video with a higher code rate can be invoked correspondingly.

For example, the video code rate can be the number of data bits transferred in unit time during video data transmission, usually the unit is kbps, i.e., kilo bits per sound. The code rate can be understood as sampling rate. The bigger the sampling rate in unit time, the higher the accuracy, and the closer to the original file the processed file. However, the volume of the file is proportional to the sampling rate, and therefore almost all coding formats emphasize how to use the lowest code rate to reach the lowest distortion.

As shown in FIG. 6, a push method based on natural information recognition according to an embodiment of the disclosure includes:

S1, a service control device receives natural information about an object to be recognized collected by an intelligent terminal and determines the category of the natural information;

S2, the service control device performs recognition according to the category of the natural information;

S3, a data search device analyzes the natural information so as to determine feature meaning thereof; and

S4, the data search device retrieves and determines matching push information according to the feature meaning, the push information preferably including an augmented reality file.

In the above method embodiment, said performing recognition according to the category of the natural information includes:

sending the natural information to an image recognition server when the natural information is image information;
sending the natural information to a text recognition server when the natural information is text information;
sending the natural information to a sound recognition server when the natural information is sound information; and
sending the natural information to a location recognition server when the natural information is location information.

When natural information about a plurality of objects to be recognized is received at the same time, recognition of different priorities of the natural information of the plurality of objects to be recognized is realized by means of recognition process control according to preset priorities, so that different priorities can be configured according to the demand of the customer, different types of customers and different priority levels, thus realizing personalized customization of services.

In the above method embodiment, said retrieving and determining matching push information according to the feature meaning includes:

the data search device retrieving to obtain a retrieval result according to the feature meaning; and
the data search device adjusting the priority of an augmented reality file in the retrieval result to the highest if the retrieval result includes the augmented reality file; and
the data search device determining the push information based on the adjusted retrieval result.

In the above embodiment, the retrieval result may include a plurality of augmented reality files and a plurality of non-augmented reality files. Thus, the plurality of augmented reality files will be arranged at the front and the plurality of augmented reality files will be arranged at the back. Meanwhile, the plurality of augmented reality files can also be sorted according to a preset priority arrangement principle (for example, when the augmented reality file not only includes an augmented reality picture but also includes an augmented reality video, and if the preset priority arrangement principle is that videos are first, then the augmented reality video is arranged at the highest priority).

In the above method embodiment, after said retrieving and determining matching push information according to the feature meaning, process control is performed on the push information to send it to a user.

In the above method embodiment, the database stores AR augmented files, the AR augmented files including but not limited to AR videos and AR pictures, and the AR augmented files are pushed to a user as information to be pushed, so as to enhance the visual experience of the user and improve user experience.

In addition, in the above method, also included are updating the database regularly and at the same time synchronizing ordinary files corresponding to the AR augmented files (augmented reality files) in the database to a cloud server.

Taking a movie poster as an example, in practical application, performing pushing based on natural information recognition with the above method includes collecting image information on the movie poster with a camera of an intelligent terminal, and sending the collected data source to a service control center. The service control center determines that this information is image information and then sending data to be analyzed of this image information to an image recognition server of a cloud server cluster. The image recognition server sends an analysis result to a data search center which performs the matching of the analysis result and extracting a corresponding movie trailer to be pushed or other video information (such as an AR augmented movie poster, a movie review, a director and actor review and so on) from a database, the service control center pushing to the intelligent terminal the video to be pushed at an appropriate time. The intelligent terminal performing AR display on the received movie and picture, thus completing video pushing.

Likewise, when the natural information is a song, the system can push information relevant to this song. For example, the system can push a customized augmented reality album cover, an augmented reality MV corresponding to the song, or relevant information about the pushed singer, lyrics and so on.

When the natural information is location information, periphery information relevant to the current location, knowledge of the local culture background, or local travel information, or a local augmented reality trailer can be pushed. Of course, the disclosure is not limited to the above listed content.

When the natural information is text information, corresponding content is pushed according to the subject described by the text information. The pushed content can be an augmented reality picture or can be an augmented reality video and so on. Of course, the disclosure is not limited to the above listed content.

In another aspect, a server is also provided according to an embodiment of the disclosure, including:

a memory for storing computer-operable instructions;
a processor for executing the computer-operable instructions stored in the memory so as to execute the following operations:
a service control device receiving natural information about an object to be recognized collected by an intelligent terminal, determining the category of its natural information, and performing recognition according to the category of the natural information;
a data search device analyzing the natural information so as to determine feature meaning thereof, and retrieving and determining matching push information according to the feature meaning, the push information preferentially including an augmented reality file.

The push method and electronic device based on natural information recognition and the client provided in the embodiments of the disclosure are beneficial for a user to learn relevant information about anything of the surrounding rapidly, which realizes the pushing of specific information of a specific thing and thus improving user experience.

The foregoing embodiments of device are merely illustrative, in which those units described as separate parts may or may not be separated physically. Displaying part may or may not be a physical unit, i.e., may locate in one place or distributed in several parts of a network. Some or all modules may be selected according to practical requirement to realize the purpose of the embodiments, and such embodiments can be understood and implemented by the skilled person in the art without inventive effort.

A person skilled in the art can clearly understand from the above description of embodiments that these embodiments can be implemented through software in conjunction with general-purpose hardware, or directly through hardware. Based on such understanding, the essence of foregoing technical solutions, or those features making contribution to the prior art may be embodied as software product stored in computer-readable medium such as ROM/RAM, diskette, optical disc, etc., and including instructions for execution by a computer device (such as a personal computer, a server, or a network device) to implement methods described by foregoing embodiments or a part thereof.

It would be appreciated by the skilled in the art that, the embodiments of the disclosure can be provided as method, system, or computer program product. Therefore, the disclosure can be implemented in various ways, such as purely by hardware, or purely by software, or a combination of software and hardware. Moreover, the disclosure can be implemented as a computer program product including one or more computer executable program codes which are stored on a computer readable memory medium (including but not limited to a disk storage or optic memory, etc.).

The disclosure is described in reference to method, device (or system), and flow chart and/or block diagram of computer program product of embodiment of the invention. It should be understood that each flow and/or block and a combination thereof in a flow chart and/or block diagram can be implemented by computer program instruction. These computer program instruction can be provided to a universal computer, a dedicated computer, an embedded processor or a processor of other programmable data processing device to generate a machine, so that a device capable of realizing functions designated by one or more flows of a flow chart and/or one or more blocks of a block diagram can be generated through execution of instructions by a computer or processor of other programmable data processing device.

These computer program instructions may be stored in a computer readable memory which can guide the computer or other programmable data processing device to operate in a special way, so that the instruction stored in the computer readable memory generates a product including an instruction device which carries out functions designated by one or more flows of a flow chart and/or one or more blocks of a block diagram. These computer program instructions can also be loaded on a computer or other programmable data processing device so as to enable a series of operations to be carried out on the computer or other programmable device to realize processing of the computer, thus providing operations for achieving functions designated by one or more flows of a flow chart and/or one or more blocks of a block diagram by the instructions executed by the computer or other programmable device.

Finally, it should be noted that, the above embodiments are merely provided for describing the technical solutions of the disclosure, but not intended as a limitation. Although the disclosure has been described in detail with reference to the embodiments, those skilled in the art will appreciate that the technical solutions described in the foregoing various embodiments can still be modified, or some technical features therein can be equivalently replaced. Such modifications or replacements do not make the essence of corresponding technical solutions depart from the spirit and scope of technical solutions embodiments of the disclosure.

None of the elements recited in the claims are intended to be a means-plus-function element within the meaning of 35 U.S.C. §112(f) unless an element is expressly recited using the phrase “means for,” or in the case of a method claim using the phrases “operation for” or “step for.”

What is claimed is:

1. A push method based on natural information recognition, comprising, at an electronic device:
receiving natural information about an object to be recognized and determining a category of the natural information;
performing recognition according to the category of the natural information;
analyzing the natural information so as to determine feature meaning of the natural information; and
retrieving and determining matching push information according to the feature meaning, the push information preferably comprising an augmented reality file.

2. The method according to claim 1, wherein said performing recognition according to the category of the natural information comprising:
sending the natural information to an image recognition server when the natural information is image information;
sending the natural information to a text recognition server when the natural information is text information;
sending the natural information to a sound recognition server when the natural information is sound information; and
sending the natural information to a location recognition server when the natural information is location information.

3. The method according to claim 1, wherein said retrieving and determining matching push information according to the feature meaning comprising:
retrieving to obtain a retrieval result according to the feature meaning; and
adjusting a priority of an augmented reality file in the retrieval result to a highest if the retrieval result comprises the augmented reality file; and
determining the push information based on the adjusted retrieval result.

4. The method according to claim 1, wherein after said retrieving and determining matching push information according to the feature meaning, process control is performed on the push information and then the same is sent to a user.

5. An electronic device, comprising:
at least one processor; and
a memory communicably connected with the at least one processor for storing instructions executable by the at least one processor, wherein execution of the instructions by the at least one processor causes the at least one processor to:
receive natural information and determine a category of the natural information and send the natural information to a recognition server matching the category thereof, wherein the natural information comprises at least one of image information, sound information, text information and location information; and
retrieve and determine matching push information according to feature meaning determined by the recognition server analyzing the natural information, the push information preferentially comprising an augmented reality file.

6. The electronic device according to claim 5, wherein the recognition server at least one of an image recognition server, a sound recognition server, a text recognition server and a location recognition server.

7. The electronic device according to claim 5, wherein execution of the instructions by the at least one processor further causes the at least one processor to perform process control on the push information and then send the same to a user.

8. The electronic device according to claim 5, wherein data is synchronized in the recognition server.

9. The electronic device according to claim 5, wherein execution of the instructions by the at least one processor further causes the at least one processor to:
update a database which stores an augmented reality file regularly; and
retrieve the push information from the database according to the feature meaning received by the recognition server.

10. An electronic device comprising:
at least one processor; and
a memory communicably connected with the at least one processor for storing instructions executable by the at least one processor, wherein execution of the instructions by the at least one processor causes the at least one processor to:
collect natural information;
send the collected natural information to a push system, wherein the push system is used for analyzing the natural information so as to determine feature meaning and retrieving and determining matching push information according to the feature meaning; and
receive the push information determined by the push system so as to display the push information, wherein the push information preferably comprises an augmented reality file.
